(19) United States
(12) Patent Application Publication
(10) Pub. No.: US 2025/0139699 A1
(43) Pub. Date: May 1, 2025

(54) COMPUTING SYSTEMS AND METHODS USING MACHINE LEARNING FOR SERVICING LOAN REQUESTS AND LOAN OFFERS

(71) Applicant: PANDO Companies Inc., Colleyville, TX (US)

(72) Inventor: Amir Giryes, Colleyville, TX (US)

(21) Appl. No.: 18/835,850

(22) PCT Filed: Feb. 6, 2023
(86) PCT No.: PCT/US2023/012426

§ 371 Date: Aug. 5, 2024

Related U.S. Application Data
(60) Provisional application No. 63/306,873, filed on Feb. 4, 2022.

(51) Int. Cl. G06Q 40/03; G06Q 10/0639; G06Q 50/16

(52) U.S. Cl. CPC G06Q 40/03; G06Q 10/06393; G06Q 50/16

(57) ABSTRACT

Disclosed herein are methods and computer systems for fulfilling loan requests and loan offers using machine learning. Lender-borrower and lender marketplace computing platforms are disclosed that allow a mixture of artificial intelligence and human intervention. Each of the platforms allow for various levels of automation and human interaction: including up to fully automated processes. In one example a method of fulfilling loan requests using machine learning includes: (1) receiving a loan request for purchasing property. (2) receiving lending criteria from multiple lenders. (3) recommending. using a machine learning algorithm. one or more of the multiple lenders for servicing the loan request based on the loan request and the lending criteria of each of the multiple lenders, and (4) distributing the loan request to at least some of the one or more of the multiple lenders.

### CROSS REFERENCE TO RELATED APPLICATION

This application claims the benefit of U.S. Provisional Application Ser. No. 63/306,873, filed by Amir Giryes on Feb. 4, 2022, entitled “COMPUTING SYSTEMS AND METHODS USING MACHINE LEARNING FOR SERVICING LOAN REQUESTS AND LOAN OFFERS,” commonly assigned with this application and incorporated herein by reference in its entirety.

### TECHNICAL FIELD

This application is directed, in general, to financing property transactions and, more specifically, to computer systems for fulfilling loan requests and loan offers.

### BACKGROUND

Purchasing property often involves obtaining a loan for at least a portion of the property's cost. This is especially true for commercial real estate. Finding the right lender for a particular purchasing opportunity, however, can be challenging. For lenders, finding lending opportunities can be challenging, also.

### SUMMARY

One aspect provides a method of fulfilling loan requests using machine learning. In one example the method includes: (1) receiving a loan request for purchasing property. (2) receiving lending criteria from multiple lenders, (3) recommending, using a machine learning algorithm, one or more of the multiple lenders for servicing the loan request based on the loan request and the lending criteria of each of the multiple lenders, and (4) distributing the loan request to at least some of the one or more of the multiple lenders.

In another aspect, the disclosure provides a method of selling existing loans using machine learning. In one example, the method includes: (1) receiving a loan offer associated with an existing property loan, (2) obtaining lending criteria from multiple loan purchasers, (3) recommending, using a machine learning algorithm, one or more of the multiple loan purchasers for assuming at least a portion of the loan based on the loan offer and loan purchaser criteria of each of the multiple loan purchasers, and (4) distributing the loan offer to at least some of the one or more of the multiple loan purchasers.

In yet another aspect, the disclosure provides a computing system for selecting lenders for a loan request. In one example, the computing system includes one or more processors to perform operations at least including: (1) receiving a loan request for purchasing property, (2) receiving lending criteria from multiple lenders, (3) recommending, using a machine learning algorithm, one or more of the multiple lenders for servicing the loan request based on the loan request and the lending criteria of each of the multiple lenders, and (4) distributing the loan request to at least some of the one or more of the multiple lenders.

In still yet another aspect, the disclosure provides a computing system for selecting loan purchasers for a loan offer. In one example, the computing system includes one or more processors to perform operations at least including: (1) receiving a loan offer associated with an existing property loan. (2) obtaining lending criteria from multiple loan purchasers, (3) recommending, using a machine learning algorithm, one or more of the multiple loan purchasers for assuming at least a portion of the loan based on the loan offer and loan purchaser criteria of each of the multiple loan purchasers, and (4) distributing the loan offer to at least some of the one or more of the multiple loan purchasers.

The disclosure also provides in one aspect a computer program product having a series of operating instructions stored on a non-transitory computer-readable medium that directs one or more processors when executed thereby to perform operations for selecting lenders for a loan request. In one example the operations: (1) receiving a loan request for purchasing property. (2) receiving lending criteria from multiple lenders, (3) recommending, using a machine learning algorithm, one or more of the multiple lenders for servicing the loan request based on the loan request and the lending criteria of each of the multiple lenders, and (4) distributing the loan request to at least some of the one or more of the multiple lenders.

The disclosure still provides another aspect of a computer program product having a series of operating instructions stored on a non-transitory computer-readable medium that directs one or more processors when executed thereby to perform operations for selecting loan purchasers for a loan offer. In one example, the operations include: (1) receiving a loan offer associated with an existing property loan, (2) obtaining lending criteria from multiple loan purchasers, (3) recommending, using a machine learning algorithm, one or more of the multiple loan purchasers for assuming at least a portion of the loan based on the loan offer and loan purchaser criteria of each of the multiple loan purchasers, and (4) distributing the loan offer to at least some of the one or more of the multiple loan purchasers.

### BRIEF DESCRIPTION

Reference is now made to the following descriptions taken in conjunction with the accompanying drawings, in which:

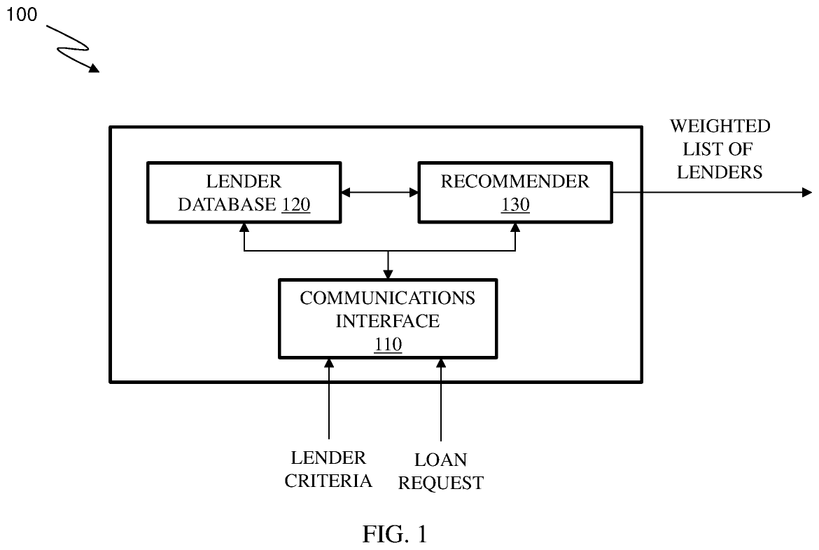

FIG. 1 illustrates a block diagram of an example of a lender-borrower computing platform constructed according to the principles of the disclosure;

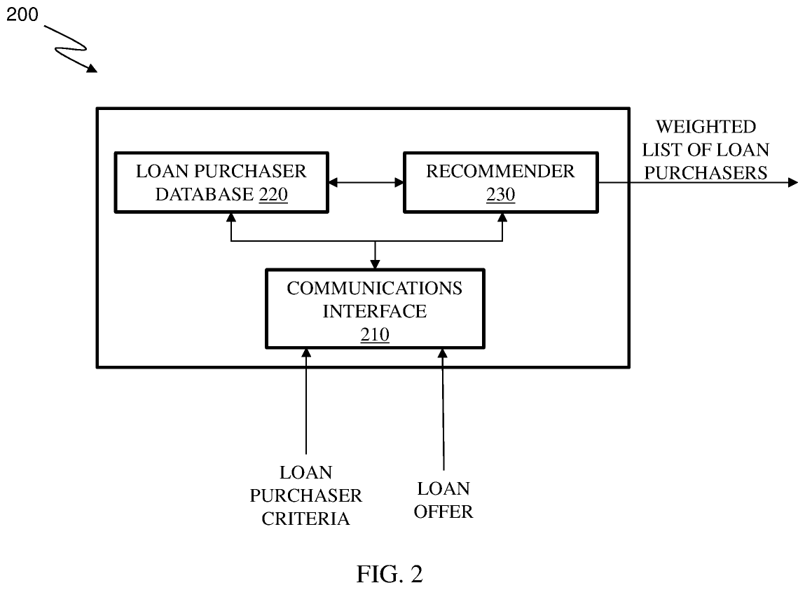

FIG. 2 illustrates a block diagram of an example of a lender-marketplace computing platform constructed according to the principles of the disclosure;

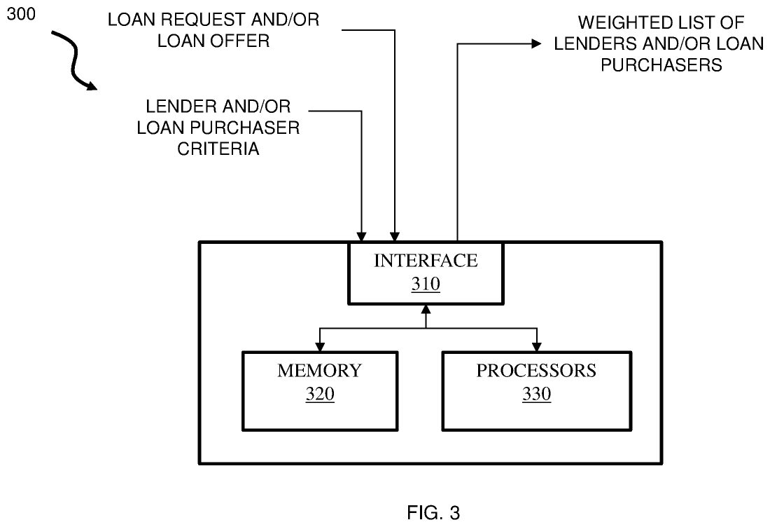

FIG. 3 illustrates a block diagram of an example of a computing system on which the lender-borrow platform and/or the lender marketplace platform can be implemented according to the principles of the disclosure;

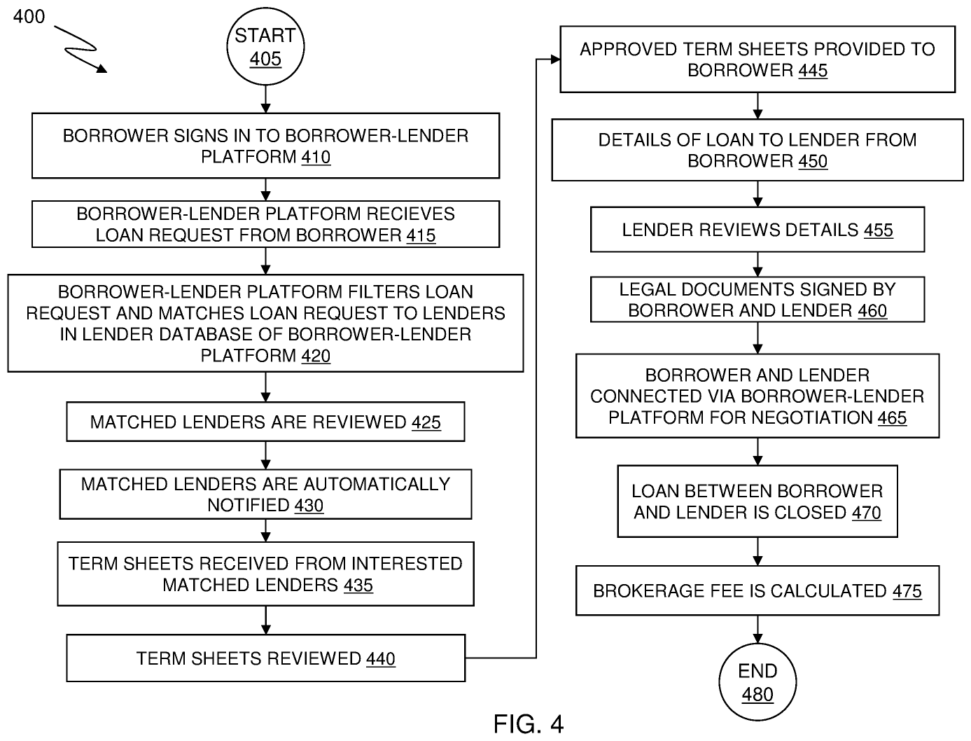

FIG. 4 illustrates a flow diagram of an example of a workflow of servicing a loan using a lender-borrow platform, such as the lender-borrower platform of FIG. 1; and

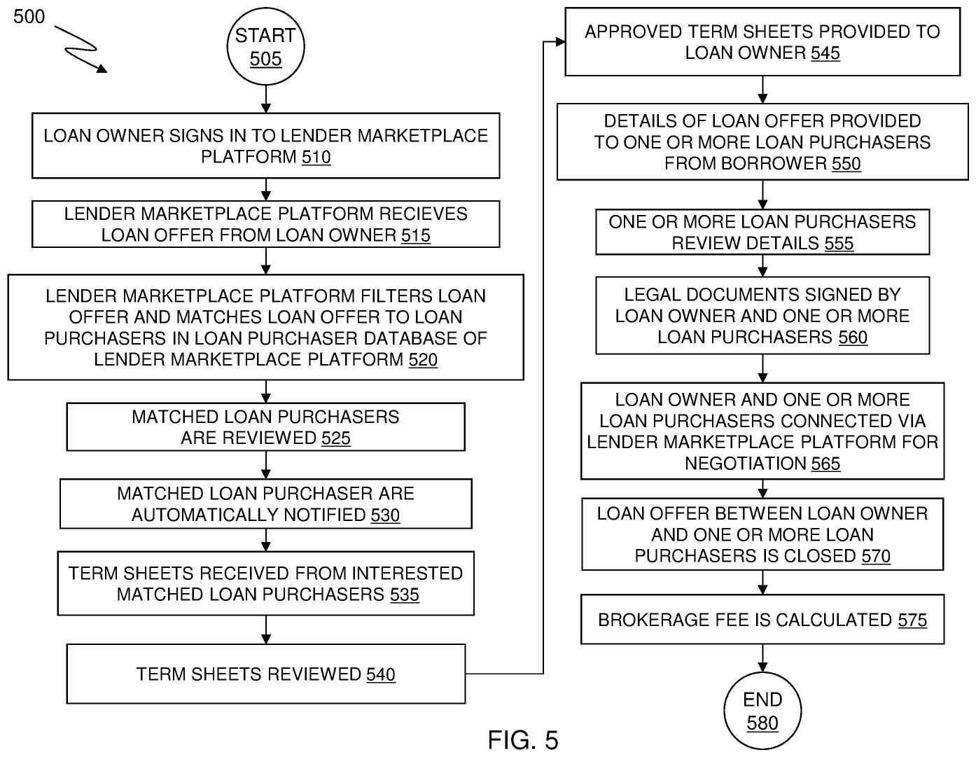

FIG. 5 illustrates a flow diagram of an example of a workflow to match existing loan owners with one or more loan purchasers using a lender marketplace platform, such as the lender marketplace platform of FIG. 2.

### DETAILED DESCRIPTION

The disclosure provides a lender-borrower platform that matches potential borrowers to one or more lenders. Lenders submit criteria on the lender-borrower platform that represents their lending appetite, which can be in the area of commercial real estate. From the submitted lender criteria, a database of lenders is created. Borrowers also submit terms of a project or purchase, referred to as a loan request, in which financing is needed. A back end machine learning algorithm, such as a recommendation algorithm, performs a best fit match between the loan request and the lender criteria from the various lenders. The matching generates a weighted list of lenders that can then be reviewed for compatibility. Along with the criteria for each of the lenders, the weighting can consider the responses/acceptances of previous loan requests delivered to the individual lenders. The review can be performed manually, automatically by a computing system, or by a combination of both. After the review, the loan request is sent to selected lenders from the weighted list. The selected lenders can be some or all of the lenders from the weighted list.

After the delivery of the loan request to the selected lenders, a financing deal can be brokered between one or more of the selected lenders and the borrower. A brokering fee can be calculated based on the financing deal. Brokering the financing deal can be performed manually, automatically by a computing system, or by a combination of both. The brokering fee can also be determined manually or automatically by the computing system.

The lender criteria and the loan request can be received by the computing system, such as a server. The computing system can be, for example, a recommender system. The lender criteria and loan request can be received via a form, such as on a web interface implemented on the computing system.

The timing advantage provided by the lender-borrower platform can be especially beneficial in certain transaction areas, such as in commercial real estate. In this area, deals are typically alive for about 60 days and there is a window of five to seven days business days to decide upon a lender. With the existing financing system, this is an insufficient amount of time to consider multiple potential lenders. The disclosed lender-borrower platform provides an adaptable mechanism to consider multiple potential lenders in parallel and allow sufficient time to close the deal within typical industry standards.

The disclosure also provides a lender marketplace platform that matches existing loan owners with one or more loan purchasers. For the lender marketplace, loan purchasers submit criteria that represents their lending appetite. A loan purchaser can be a lender, such as discussed above with the borrow-lender platform, or can be an equity investor. From the submitted criteria, a database of loan purchasers is created. Lender criteria from the borrower-lender platform can be loaded into the database of the lender marketplace. An application programming interface (API) can be used to automatically transfer the lender criteria information to the lender marketplace. Loan owners also submit information of an existing loan that is for sale or syndication, which is referred to as a loan offer. A back end machine learning algorithm, such as a recommendation algorithm, performs a best fit match between the loan offer and the criteria from the various loan purchasers. The algorithm can match a loan purchaser to a portion of the value of the loan offer or to an entirety of the loan offer. The algorithm can determine the value of one or more portions of the loan offer based on the loan purchaser criteria. For example, the total amount of the loan offer may be 25 million dollars and there is not a loan purchaser who has a criteria that indicates an appetite for the entire 25 million dollars. The algorithm can determine the value of different portions of the loan offer, i.e., syndication amounts, based on the loan provider criteria. The algorithm can also determine the mixture of lenders and equity investors for the loan offer based on several factors, such as, the loan purchaser criteria and the value of the loan offer.

The matching generates a weighted list of loan purchasers that can then be reviewed for compatibility. Along with the criteria for each of the loan purchasers, the weighting can consider the responses/acceptance of previous loan offers delivered to the individual loan purchasers. The review can be performed manually, automatically by a computing system, or by a combination of both. After the review, the loan offer is sent to selected loan purchasers from the weighted list. The selected loan purchasers can be some or all of the loan purchasers from the weighted list.

After the delivery of the loan offer to the selected loan purchasers, a financing deal can be brokered between one or more of the selected loan purchasers and the loan owner. A brokering fee can be calculated based on the financing deal. Brokering the financing deal can be performed manually, automatically by a computing system, or by a combination of both. The brokering fee can also be determined manually or automatically by the computing system.

Similar to the borrower-lender platform, the loan purchaser criteria and the loan offer can be received by the computing system, such as a server, which can be a recommender system. The loan purchaser criteria and loan offer can be received via a form, such as on a web interface implemented on the computing system.

In both platforms, the weighting and filtering of the machine learning algorithm can consider the product, i.e., the loan request of the loan offer, similarity of the product to previous products that were accepted, the lender and/or loan purchaser criteria for the different platforms, and rewarding past behavior for accepting the previous products. The past behavior can be collected, saved, and applied by the algorithm. Thus, instead of simply considering the criteria that has been input by the lenders and/or loan purchasers, the previous actions regarding acceptance of loan requests or loan offers are also considered. As such, from at least this aspect the lender-borrower platform and the lender marketplace platform provide adaptable systems for satisfying loan requests and loan offers based on real actions instead of simply the criteria that can be input into a system.

The matching performed by the algorithm can include running a cosine similarity based on specific criteria that has been identified as priority fits based on, for example, historical data and user intelligence. Other criteria can then be considered for fine tuning the matching. A weighted list can then be generated for reviewing and selection.

The disclosed platforms provide new mechanisms for processing loan requests and loan offers. In an industry that places importance in human interaction, the disclosed platforms allow a mixture of artificial intelligence and human intervention. Advantageously, human quality control can be used with both the lender-borrower platform and the lender marketplace platform. Each platform disclosed herein allows for various levels of automation and human interaction; including up to fully automated processes.

FIG. 1 illustrates a block diagram of an example of a lender-borrower platform 100 constructed according to the principles of the disclosure. The lender-borrower platform 100 is configured to match potential borrowers to one or more lenders. The lender-borrower platform 100 can be implemented on a computing system having one or more processors and one or more memory or data storage. The computing system can be a server or another computing device that includes an interface for communicating (transmitting and receiving) data in addition to the processors and memory. The lender-borrower platform 100 can be accessible via interconnected communication networks, such as an internet. As such, the lender-borrower platform 100 can be based on a web application that executes on a server and is accessed by borrowers and lenders through a web browser using an active connection. Accordingly, the lender-borrower platform 100 can include a communications interface 110 that communicates (transmits and receives) data via a communications network, such as the Internet. The communication interfaces 110 can also receive data via input devices, such as a keypad, keyboard, touchpad, touchscreen, microphones, and other user input devices. As such the lender-borrower platform 100 can also include one or more screens or displays. The lender-borrower platform 100 also includes a lender database 120 and a recommender 130.

The lender database 120 stores lender criteria for various lenders. The lender criteria can be received via the communications interface 110 and distributed to the lender database for storage. The lender criteria can include, lender information, loan types of interest, investment strategies, market types, asset class, geographical preferences, high level loan details, and low level loan details. The lender criteria can be received by various means, such as via a web-based form or by manual input from a user using one or more input device. The lender-database 120 can be a relational database, such as an object relational database or a standard structured query language (SQL) database.

The recommender 120 is configured to recommend one or more lenders for servicing a loan request based on the loan request and the lending criteria of the multiple lenders stored in the lender database. The recommender 120 can be implemented on one or more processors executing a machine learning algorithm. The algorithm can be a recommendation algorithm that performs a best fit match between the loan request and the lender criteria from the various lenders. The recommender 120 can generate a weighted list of the recommended lenders based on the loan request and the lending criteria of each of the multiple lenders stored in the database 120. Advantageously, the weighted list can be generated based on responses of the multiple lenders to previous loan requests distributed thereto. For example, a lender's response to a previous loan request, favorable or unfavorable, that is similar to the present loan request can be considered. The machine learning algorithm can generate the weighted list by creating a matrix of data points associated with the loan request and the multiple lenders and weighting at least some of the data points on a sliding scale. The weighting can vary for different loan requests and can vary due to learning by the recommender 120. The recommender 120 can simultaneously process multiple loan requests.

The recommender 130 is further configured to distribute the loan request to at least some of the recommended lenders. The recommender 130 can simultaneously distribute the loan request to the recommended lenders. The distribution by the recommender 130 can also be performed automatically. The recommender 130 can automatically and simultaneously distribute the loan request via the communications interface 110 over the communications network. The loan request can include, for example, loan type, real estate type, deal type, financial details, market type, property details, closing date, and borrower information.

The one or more lenders recommended for servicing the loan request can be reviewed before sending out the loan request. Based on the review, some of the recommended lenders may be remove from the weighted list. Additionally, other lenders who were not recommended can be added to receive the loan request. The review can be manual or can be performed by a processor. As such, the lender-borrower platform 100 can also be configured to review and select from the recommended lenders before distributing the weighted list of lenders. In addition, the lender-borrower platform 100 can be configured to automatically calculate a brokering fee based on a percentage of debt corresponding to the loan request. The additional logic for the review and calculation of brokering fees can be stored on the one or more memories or data storage of the lender-borrow platform 100 and executed by one or more of the processors.

FIG. 2 illustrates a block diagram of an example of a lender-marketplace platform 200 constructed according to the principles of the disclosure. The lender-marketplace platform 200 is configured to match existing loan owners with one or more loan purchasers. The lender-marketplace platform 200 can be implemented on a computing system having one or more processors and one or more memory or data storage. The computing system can be a server or another computing device that includes an interface for communicating data in addition to the processors and memories. The lender-marketplace platform 200 can be accessible via interconnected communication networks, such as an internet. As such, the lender-marketplace platform 200 can be based on a web application that executes on a server and is accessed by borrowers and lenders through a web browser using an active connection. Accordingly, the lender-marketplace platform 200 can include a communications interface 210 that communicates data via a communications network, such as the Internet. The communication interface 210 can also receive data via input devices, such as a keypad, keyboard, touchpad, touchscreen, microphones, and other user input devices. The communications interface 210 can be similarly configured as the communications interface 110. As with the borrow-lender platform 100, the lender-marketplace platform 200 can also include a screen or display as a user interface. The lender-marketplace platform 200 also includes a loan purchaser database 220 and a recommender 230.

The loan purchaser database 220 stores loan purchaser criteria for various purchasers. A loan purchaser can be a lender, such as discussed above with the borrow-lender platform 100, or can be an equity investor. The loan purchaser criteria can be received via the communications interface 210 and distributed to the loan purchaser database 220 for storage. The loan purchaser criteria can include lender criteria including, for example, lender information, loan types of interest, investment strategies, market types, asset class, geographical preferences, high level loan details, and low level loan details. The loan purchaser criteria can also include equity investor criteria including, for example, high level investment information, geographical preferences, high level investment details, granular investment details, borrower details, typical deal structure description. The loan purchaser criteria can be received by various means, such as via a web-based form or by manual input from a user using one or more input device. The lender criteria portion of the loan purchaser criteria can be loaded into the loan purchaser database 220 from the lender database 120 via, for example, an API; this can be done automatically. The loan purchaser database 220 can be a relational database have a structure of various types, such as the lender database 120 of FIG. 1. The loan purchaser database 220 and the lender database 120 can be stored on one or more memories of data storage, such as represented by memory 320 in FIG. 3.

The recommender 230 is configured to recommend one or more loan purchasers for servicing a loan offer based on the loan offer and the loan purchaser criteria of the multiple loan purchasers stored in the loan purchaser database 220. The recommender 230 can be implemented on one or more processors executing a machine learning algorithm. The algorithm can be a recommendation algorithm that performs a best fit match between the loan offer and the criteria from the various loan purchasers. The match for the loan purchasers can be for a portion of the loan offer in addition to the entire loan offer. The recommender 230 can generate a weighted list of the recommended loan purchasers based on the loan offer and the loan purchaser criteria of each of the multiple loan purchasers stored in the database. Advantageously, the weighted list can be generated based on responses of the multiple loan purchasers to previous loan offers distributed thereto. For example, a response of an equity investor to a previous loan offer that is similar to the present loan offer can be considered. The machine learning algorithm can generate the weighted list by creating a matrix of data points associated with the loan offer and the multiple loan purchaser and weighting at least some of the data points on a sliding scale. The weighting can change for different loan offers and can change due to learning by the machine learning algorithm. The recommender 230 can simultaneously process multiple loan offers.

The recommender 230 is further configured to distribute the loan offer, or a portion thereof, to at least some of the recommended loan purchasers. The recommender 230 can simultaneously distribute the loan offer or particular portions thereof to the recommended loan purchasers. The distribution by the recommender 230 can also be performed automatically. The recommender 230 can automatically and simultaneously distribute the loan offer via the communications interface 210 over the communications network. The loan offer can include, for example, loan type, real estate type, deal type, financial details, market type, property details, closing date, and loan servicer information. When the loan offer relates to syndication, the loan offer can further include syndicator information, credit score, requested participation value, current value, and interest rate.

The loan purchasers recommended for the loan offer can be reviewed before sending out the loan offer. Based on the review some, but not all, of the recommended loan purchasers may be selected to receive the loan offer as constructed and recommended by the recommender 230. Some loan purchasers can be added during the review. The portions of the loan offer can be adjusted during the review if applicable. The review can be manual or can be performed by a processor. As such, the lender-marketplace platform 200 can also be configured to review and select from the recommended loan purchasers before distributing the weighted list of loan purchasers. In addition, the lender-marketplace platform 200 can be configured to automatically calculate a brokering fee based on a percentage of debt corresponding to the loan offer. The additional logic for the review and calculation of brokering fee can be stored on one or more of the memories or data storage the lender-marketplace platform 200 and executed by one or more of the processors.

FIG. 3 illustrates a block diagram of an example of a computing system 300 on which the lender-borrow platform and/or the lender marketplace platform can be implemented according to the principles of the disclosure. The computing system 300 is typically implemented on one or more computing devices that can be in a cloud environment, a data center, a lab, or a corporate office. The computing system 300 can be, for example, a laptop, a server, a desktop computer, a cloud computing system, other computing systems, or a combination thereof, which is operable to perform the processes and methods described herein, such as one or more of the steps performed by the lender-borrower platform 100 and/or the lender marketplace platform 200. For example, the computing system 300 can automatically perform at least some of the steps performed by the lender-borrower platform 100 and/or the lender marketplace platform 200. The computing system 300 includes an interface 310, one or more memories represented by memory 320, and one or more processors 330.

The interface 310 is configured to receive and transmit data. As such, the interface 310 includes the necessary circuitry, software, logic, for communicating data. The interface 310 can receive criteria from lenders and loan purchasers. The criteria can be received via a web-based form or by manual input from a user using an input device. An API can be used to automatically move lender criteria from one database, such as a lender database, to another database, such as a loan purchaser database. The interface 310 can also receive loan requests and/or loan offers. Output data, such as weighted lists of lenders and/or loan purchasers, can also be sent from the processor 330 or memory 320 via the interface 310 to a screen for display and analysis. The loan offers can also be sent to loan purchasers. The output data can also include calculated brokering fees and review/analysis of selected lenders and/or loan purchasers. The computing system 300 can also include the screen that can be used for analysis.

The memory 320 is configured to store the different criteria, loan requests, loan offers, and operating instructions that direct operation of the one or more processors 330. The memory 320 can also store previous responses from lenders and/or loan purchasers. The operating instructions can correspond to various ones of the automated steps performed by the platforms 100 and 200 of FIGS. 1 and 2. A trained machine learning model can also be stored on the memory 320 that is used in selecting lenders and/or loan purchasers. The memory 320 is a non-transitory computer readable medium.

At least one of the one or more processors 330 can be configured to use machine learning to recommend lenders to service loan requests based on the loan requests and the lending criteria of lenders. Additionally, at least one of the one or more processors 330 can be configured to use machine learning to recommend loan purchasers for assuming at least a portion of a loan based on loan offers and loan purchaser criteria as disclosed herein. The one or more processors 330 can be configured to operate according to one or more algorithms corresponding to at least some of the functions of the platforms 100 and 200 of FIGS. 1 and 2.

FIG. 4 illustrates a flow diagram of an example of a workflow 400 of servicing a loan using a lender-borrow platform, such as lender-borrower platform 100 of FIG. 1. At least some of the step of the workflow 400 can be performed automatically and at least some of the steps can be performed automatically or manually. One or more of the automatic steps can be performed according to a series of operating instructions that correspond to one or more algorithms for servicing loans. With a mixture, the workflow 400 can provide a balanced combination of computer and human interaction for servicing loans. The loan can be for purchasing real estate, such as commercial real estate. The workflow 400 begins in step 405.

In step 410, a borrower signs in to a borrower-lender platform such as disclosed herein. The borrower can sign in via a web-interface. The sign in process can be a secure process that uses, for example, secure socket layer (SSL) encryption. Hypertext Transfer Protocol Secure (HTTPS) protocol can be used for signing in.

In step 415, the borrower-lender platform receives a loan request from the borrower. The borrower can submit the loan request (i.e., loan application) to the borrower-lender platform via a dashboard of the platform. The loan request can be stored in a database of the platform. The platform can also include a lender database that includes lender criteria. The lender criteria from multiple lenders can have already been uploaded and stored in the lender database.

The borrower-lender platform filters the loan request and matches the loan request to lenders in the lender database of the borrower-lender platform in step 420. A machine learning recommendation algorithm can be used to process the loan request and perform the matching. For example, recommender 130 can perform the matching using a recommendation algorithm as disclosed herein. A list of matched lenders can be generated as a result of the processing. The list can be a weighted list indicating, for example, a percentage of matching for the different lenders.

In step 425, the matched lenders are reviewed. The review can be an automated review performed by the borrow-lender platform. The review can also be a manual review. The review can be a quality assurance/care review to ensure clean, correct data and accurate matches. The number of matched lenders can change, via additions or subtractions, due to the review process.

After the review process, matched lenders are automatically notified in step 430. The notified matched lenders are those who survived the review process. As such, the number of notified matched lenders can be less than or greater than the number originally matched. The lenders can be securely notified via electronic communications. The borrow-lender platform can send details of the loan requests to the matched lenders via a dashboard of each matched lender.

In step 435, term sheets are received from interested matched lenders. The term sheets can be received via an interface of the borrow-lender platform. The term sheets can be received via a web-based form. The borrower-lender platform notes the received term sheets that were received and also those lenders who did not respond. This information can be saved and considered for subsequent matching processes. For example, the response from the matched lenders can be received and provided to the recommendation machine learning algorithm for learning and weighting. Accordingly, actions of lenders can be used for determining subsequent matches.

In step 440, the received term sheets are reviewed. The review process can be a quality assurance/care review that is automated, manual, or a combination of both. One or more term sheets can be approved via the review process.

At least one of the approved term sheets are provided to the borrower in a secure data room shared by borrower and lender in step 445. As noted, multiple matched lenders can be approved and sent to the borrower. As such, the borrower can select one or more and proceed. Additionally, only one lender may be approved and sent to the borrower or the borrower may only select one approved lender from multiple ones for further discussions.

Whether for one or multiple lenders, the details of the loan request are shared between the borrower and the lender in step 450. The details can be received by the borrower-lender platform and a secure data room established for sharing between the borrower and lender. The details can be uploaded via an interface of the borrower-lender platform.

The lender or lenders review the loan request details in step 455. At this point, multiple lenders may still be in play and a single lender is selected by the borrower or only one lender may remain after the review. Once a single lender remains, legal documents are signed by the borrower and the lender in step 460. The legal documents can be signed via an electronic signature application. The borrower-lender platform can automatically generate the legal documents and send to the borrower and lender for signatures. The sending and signing of the legal documents can occur before the identity of the borrower and lender are revealed. The signed legal documents can be uploaded to the borrower-lender platform to confirm signatures. Once the signatures are approved, the workflow 400 can continue to step 465.

In step 465, the borrower and lender are connected via the borrower-lender platform for negotiation. As such, the borrower-lender platform reveals the identity of the borrower and lender to each other. The borrower-lender platform can provide a secure connection for the negotiations.

The loan between the borrower and lender is closed in step 470. The closing process can be established by the borrower-lender platform and can be, or at least a portion, can be performed remotely. The borrow-lender platform can establish audiovisual connections for the closing. Remote electronic conferencing and electronic signatures can be used for remote notarization of documents. The borrower-lender platform can also setup in person closings.

In step 475, a brokerage fee is calculated for the loan. The borrower-lender platform can automatically calculate the brokerage fee and automatically deposit the brokerage fee in a designated account. The brokerage fee can also be manually calculated. In step 480, the workflow 400 ends.

FIG. 5 illustrates a flow diagram of an example of a workflow 500 to match existing loan owners with one or more loan purchasers using a lender marketplace platform, such as lender marketplace platform 200 of FIG. 2. At least some of the steps of the workflow 500 can be performed automatically and at least some of the steps can be performed automatically or manually. One or more of the automatic steps can be performed according to a series of operating instructions that correspond to one or more algorithms for matching loan owners with loan purchasers. With a mixture, the workflow 500 can provide a balanced combination of computer and human interaction for selling or syndicating loans. The loan can be for real estate, such as commercial real estate. The workflow 500 begins in step 505.

In step 510, a loan owner signs in to a lender marketplace platform such as disclosed herein. The loan owner can sign in via a web-interface. The sign in process can be a secure process that uses, for example, SSL encryption. HTTPS protocol can be used for signing in.

In step 515, the lender marketplace platform receives a loan offer from the loan owner. The loan owner can submit the loan offer to the lender marketplace platform via a dashboard of the platform. The loan offer can be stored in a database of the platform. The platform can also include a loan purchaser database that includes loan purchaser criteria. The loan purchaser criteria from multiple loan purchasers can have already been uploaded and stored in the loan purchaser database.

The lender marketplace platform filters the loan offer and matches the loan offer to loan purchasers in the loan purchaser database of the lender marketplace platform in step 520. A machine learning recommendation algorithm can be used to process the loan offer and perform the matching. For example, recommender 230 can perform the matching using a recommendation algorithm as disclosed herein. A list of matched loan purchasers can be generated as a result of the processing. The list can be a weighted list indicating, for example, a percentage of matching for the different loan purchasers.

In step 525, the matched loan purchasers are reviewed. The review can be an automated review performed by the lender marketplace platform. The review can also be a manual review. The review can be a quality assurance/care review to ensure clean, correct data and accurate matches. The number of matched loan purchasers can change, via additions or subtractions, due to the review process.

After the review process, matched loan purchasers are automatically notified in step 530. The notified matched loan purchasers are those who survived the review process. As such, the number of notified matched loan purchasers can be less than or greater than the number originally matched. The loan purchasers can be securely notified via electronic communications. The lender marketplace platform can send details of the loan offers to the matched loan purchasers via a dashboard of each matched loan purchaser.

In step 535, term sheets are received from interested matched loan purchasers. The term sheets can be received via an interface of the lender marketplace platform. The term sheets can be received via a web-based form. The lender marketplace platform notes the received term sheets that were received and also those loan purchasers who did not respond. This information can be saved and considered for subsequent matching processes. For example, the response from the matched loan purchasers can be received and provided to the recommendation machine learning algorithm for learning and weighting. Accordingly, actions of loan purchasers can be used for determining subsequent matches.

In step 540, the received term sheets are reviewed. The review process can be a quality assurance/care review that is automated, manual, or a combination of both. One or more term sheets can be approved via the review process.

At least one of the approved term sheets are provided to the loan owner in step 545. The lender marketplace can provide a secure data room for sharing of the term sheet(s) between the loan purchaser(s) and loan owner. As noted, multiple matched loan purchasers can be approved and sent to the loan owner. As such, the loan owner can select one or more and proceed. Additionally, only one loan purchaser may be approved and sent to the loan owner or the loan owner may only select one approved loan purchaser from multiple ones for further discussions.

Whether for one or multiple loan purchasers, the details of the loan offer are shared between the loan owner and the loan purchaser in step 550. The details can be received by the lender marketplace platform and a secure data room established for sharing between the loan owner and loan purchaser. The details can be uploaded via an interface of the lender marketplace platform.

The loan purchaser or loan purchasers review the loan offer details in step 555. At this point, multiple loan purchasers may still be in play and a single loan purchaser of a group of loan purchasers is selected by the loan owner. Once a single loan purchaser or purchasing group remains, legal documents are signed by the loan owner and the purchasing group in step 560, wherein the purchasing group can include a single loan purchaser. The legal documents can be signed via an electronic signature application. The lender marketplace platform can automatically generate the legal documents and send to the loan owner and loan purchaser(s) for signatures. The sending and signing of the legal documents can occur before the identity of the loan owner and loan purchaser are revealed. The signed legal documents can be uploaded to the lender marketplace platform to confirm signatures. Once the signatures are approved, the workflow 500 can continue to step 565.

In step 565, the loan owner and loan purchaser are connected via the lender marketplace platform for negotiation. As such, the lender marketplace platform reveals the identity of the loan owner and loan purchaser to each other. The lender marketplace platform can provide a secure connection for the negotiations.

The loan between the loan owner and loan purchaser is closed in step 570. The closing process can be established by the lender marketplace platform and can be, or at least a portion, can be performed remotely. The lender marketplace platform can establish audiovisual connections for the closing. Remote electronic conferencing and electronic signatures can be used for remote notarization of documents. The lender marketplace platform can also setup in-person closings.

In step 575, a brokerage fee is calculated for the loan. The lender marketplace platform can automatically calculate the brokerage fee and automatically deposit the brokerage fee in a designated account. The brokerage fee can also be manually calculated. In step 580, the workflow 500 ends.

Each of the lender criteria, equity criteria, loan request, and loan offer can include multiple elements or data points. For example, as noted herein the lender criteria can include lender information, loan types of interest, investment strategies, market types, asset class, geographical preferences, high level loan details, and low level loan details. The lender information can include contact information, entity type (Private Lender, Debt Fund, Hard Money, etc.) and referral information if any. The lender criteria can also include lender preferences. For example, lender preferences can be determined using questions such as, does the lender participate in loan syndication, lend to non-US domestic sponsors, allow mezzanine loans, do Property Assessed Clean Energy (PACE) loans, want matches filtered based on location of the borrower, or do lender ground leases. Examples of loan types of interest are permanent, construction, bridge, and mezzanine. The investment strategies can include core, opportunistic, core plus, heavy rehab, value-add, and development. The market types can be primary, secondary, and tertiary, and the asset classes can range from A to D. The geographical preferences can be based on regions, metropolitan statistical areas (MSA) markets, states, or a combination thereof. The high level loan details can include min/max loan size, minimum interest rate, maximum Loan-to-Value (LTV), maximum Loan-to-Cost (LTC), and minimum debt service coverage ratio (DSCR). The low level loan details can include the maximum LTV and/or the maximum LTC for particular fields, such as office, hospitality, retail, industrial, land, multifamily, senior housing etc. of different types of loans, such as permanent, construction loans, bridge, and mezzanine. The low level loan details can also include commercial mortgage-backed security (CMBS) and/or Non-Recourse lending capacity.

Similarly, the equity investor criteria can includes high level investment information, geographical preferences, high level investment details, granular investment details, borrower details (including preferences for filtering and requirements), and typical deal structure descriptions. The high level investment details can include minimum and maximum investment size, minimum and maximum investment period, minimum internal rate of return percentage (IRR %), minimum average cash on cash percentage, and hold period.

The loan request can include loan type, real estate type, deal type, financial details, market type, property details, closing date, and borrower information. The financial details can include purchase price, total deal cost, interest only period, expected interest rate, pro-forma debt-service coverage ratio, and class (e.g., A to D). The property details can include the type of property, such as office, senior housing, multifamily, warehouse, etc. Specific information corresponding to the type of property can also be included. For example, for senior housing when built, number of buildings, senior housing strategy, management, etc. The borrower information can include liquidity, net worth, and contact information.

The loan offer can include similar information as the loan request. Exceptions can include pro-forma net operating income (NOI) and in-place NOI. Additional information can include loan servicer information, seller information, credit score, loan origination date, current value, and interest rate. When the loan offer includes syndication, the following additional information may be collected: syndicator information, credit score, and requested participation value.

Not all of the data points may be used in each instance. Additionally, each particular data point can be weighted differently for different loan requests or loan offers. Furthermore, data points/matrices/connections/relationships can also be used for filtering and matching. For example, filtering can be done by geographical data such as city, zip code, or subregions, rather than MSA. Historical terms given by banks can also be collected to predictively build term sheets. As such the borrower-lender platforms and the lender marketplace platforms can build term sheets that could then be modified for particular uses. The platforms can also use a web crawler and data scraping algorithms to collect historical loans organized by lender and loan type in order to generate leads on prospective new lenders.

As will be appreciated by one of skill in the art, the disclosure or parts thereof may be embodied as a method, system, or computer program product. Accordingly, the features disclosed herein, or at least some of the features, may take the form of an entirely hardware embodiment, an entirely software embodiment (including firmware, resident software, micro-code, etc.) or an embodiment combining software and hardware aspects all generally referred to herein as a “circuit” or “module.” Some of the disclosed features may be embodied in or performed by various processors, such as digital data processors or computers, wherein the computers are programmed or store executable programs of sequences of software instructions to perform one or more of the steps of the methods. Thus, features or at least some of the features disclosed herein may take the form of a computer program product on a non-transitory computer-usable storage medium having computer-usable program code embodied in the medium. The software instructions of such programs can represent algorithms and be encoded in machine-executable form on non-transitory digital data storage media.

Thus, portions of disclosed examples may relate to computer storage products with a non-transitory computer-readable medium that have program code thereon for performing various computer-implemented operations that embody a part of an apparatus, device or carry out the steps of a method set forth herein. Non-transitory used herein refers to all computer-readable media except for transitory, propagating signals. Examples of non-transitory computer-readable media include, but are not limited to: magnetic media such as hard disks, floppy disks, and magnetic tape; optical media such as CD-ROM disks; magneto-optical media such as floptical disks; and hardware devices that are specially configured to store and execute program code, such as ROM and RAM devices. Configured or configured to means, for example, designed, constructed, or programmed, with the necessary logic and/or features for performing a task or tasks. Examples of program code include both machine code, such as produced by a compiler, and files containing higher level code that may be executed by the computer using an interpreter.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Those skilled in the art to which this application relates will appreciate that other and further additions, deletions, substitutions and modifications may be made to the described embodiments.

Various aspects of the disclosure can be claimed including those noted in the summary. Each of the aspects noted in the summary may have one or more of the elements of the dependent claims presented below in combination.

1. A method of fulfilling loan requests using machine learning, comprising:
receiving a loan request for purchasing property, wherein the property is commercial real estate;
receiving lender criteria from multiple lenders;
recommending, using a machine learning algorithm, one or more of the multiple lenders for servicing the loan request based on the loan request and the lender criteria of each of the multiple lenders; and
distributing the loan request to at least some of the one or more of the multiple lenders.

2. The method as recited in claim 1, wherein the recommending includes generating a weighted list of one or more of the multiple lenders based on the loan request and the lender criteria of each of the multiple lenders.

3. The method as recited in claim 2, wherein generating the weighted list is based on responses of the multiple lenders to previous loan requests distributed thereto.

4. The method as recited in claim 2, wherein the machine learning algorithm generates the weighted list by creating a matrix of data points associated with the loan request and the multiple lenders and weighting at least some of the data points on a sliding scale.

5. The method as recited in claim 1, further comprising reviewing the one or more multiple lenders recommended for servicing and selecting at least some of the one or more multiple lenders based on the reviewing, wherein the distributing is based on the selecting.

6. (canceled)

7. The method as recited in claim 5, wherein at least one of the reviewing and the selecting is performed automatically by a computing device.

8. The method as recited in claim 1, wherein the distributing is simultaneously and is performed automatically by a computing device.

9. (canceled)

10. The method as recited in claim 1, wherein the loan request includes one or more of loan type, real estate type, deal type, financial details, market type, property details, closing date, or borrower information.

11. The method as recited in claim 1, wherein the lending criteria includes one or more of lender information, loan types of interest, investment strategies, market types, asset class, geographical preferences, high level loan details, or low level loan details.

12. The method as recited in claim 1. further comprising automatically calculating a brokering fee based on a percentage of debt corresponding to the loan request.

13. A method of selling existing loans using machine learning, comprising:
receiving a loan offer associated with an existing property loan, wherein the property is commercial real estate;
obtaining lender criteria from multiple loan purchasers;
recommending, using a machine learning algorithm, one or more of the multiple loan purchasers for assuming at least a portion of the loan based on the loan offer and loan purchaser criteria of each of the multiple loan purchasers; and
distributing the loan offer to at least some of the one or more of the multiple loan purchasers.

14. The method as recited in claim 13, wherein the loan purchasers are lenders, equity investors, or a combination of both.

15. The method as recited in claim 13, wherein the recommending includes generating a weighted list of one or more of the multiple loan purchasers based on the loan offer and the criteria of each of the multiple loan purchasers, wherein generating the weighted list is based on responses of the multiple loan purchasers to previous loan offers distributed thereto.

16. (canceled)

17. The method as recited in claim 15, wherein the machine learning algorithm generates the weighted list by creating a matrix of data points associated with the loan offer and the multiple loan purchasers and weighting at least some of the data points on a sliding scale.

18. The method as recited in claim 13, further comprising reviewing the one or more multiple loan purchasers recommended for servicing and selecting at least one of the one or more recommended loan purchasers, wherein the distributing is based on the selecting and is performed automatically by a computing system.

19. (canceled)

20. The method as recited in claim 18, wherein at least one of the reviewing and selecting are performed automatically by a computing system.

21-22. (canceled)

23. The method as recited in claim 13, wherein the lender criteria includes one or more of lender information, loan types of interest, investment strategies, market types, asset class, geographical preferences, high level loan details, or low level loan details.

24. The method as recited in claim 13, wherein the equity investor criteria includes one or more of high level investment information, geographical preferences, high level investment details, granular investment details, or borrower details.

25. The method as recited in claim 13, wherein the loan offer includes one or more of loan type, real estate type, deal type, financial details, market type, property details, closing date, or loan servicer information.

26. The method as recited in claim 13, wherein when the loan offer relates to syndication, the loan offer further includes one or more of loan servicer information, syndicator information, credit score, requested participation value, current value, or interest rate.

27. A computing system for selecting lenders for a loan request, comprising:
one or more processors to perform operations at least including:
receiving a loan request for purchasing property;
receiving lender criteria from multiple lenders;
recommending, using a machine learning algorithm, one or more of the multiple lenders for servicing the loan request based on the loan request and the lender criteria of each of the multiple lenders; and
distributing the loan request to at least some of the one or more of the multiple lenders.

28. A computing system for selecting loan purchasers for a loan offer, comprising:
one or more processors to perform operations at least including:
receiving a loan offer associated with an existing property loan;
obtaining lender criteria from multiple loan purchasers;
recommending, using a machine learning algorithm, one or more of the multiple loan purchasers for assuming at least a portion of the loan based on the loan offer and loan purchaser criteria of each of the multiple loan purchasers; and
distributing the loan offer to at least some of the one or more of the multiple loan purchasers.

29-30. (canceled)
